(19) United States
(12) Patent Application Publication
(10) Pub. No.: US 2007/0094334 A1
(43) Pub. Date: Apr. 26, 2007

(54) Service/client synchronization

(75) Inventors: William R. Hoffman, Redmond, WA (US); Steven F. Schreiber, Redmond, WA (US); Marcus Jon Jager, Boulder Creek, CA (US); Shan Jiang, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/256,294

(22) Filed: Oct. 21, 2005

(51) Int. Cl. G06F 15/16

(52) U.S. Cl. 709/206

(57) ABSTRACT

Embodiments, of email service and client synchronization are presented herein.

### BACKGROUND

Email services have been rapidly growing in popularity during recent years, and continue to handle ever increasing quantities of email. Such services provide users with techniques for sending email quickly and inexpensively to recipients around the world. In addition, the users of such services are often able to download their email from the service at a variety of locations, and/or using different client devices. For example, a user of an email service may check his email in the morning using a personal computer at home and then again later in the day using another computer located at the user's workplace, and then again in the evening using a mobile phone.

Although the increased flexibility and convenience provided by an email services may be appreciated by the users, the email service is faced with a difficult task of keeping multiple client devices, with which a user may access his account, synchronized (i.e., “in sync”) with the email service. For example, the email service may attempt to keep the email that the user has on his personal computer synchronized with the email that is on the email service. Additionally, the email service may also attempt to keep email on each of a variety of other client devices used by the user to access the email account synchronized with the email that is on the email service. Past efforts to achieve efficient synchronization of multiple client devices with an Internet email service have been unsatisfactory, such as through use of significant amount of client and service resources.

### SUMMARY

Email service and client synchronization is described. In one embodiment a synchronization request is received at a server from a client to synchronize the client's email account. The synchronization request includes a generation identifier (ID) that identifies a group of changes to the email account which have been processed by the client. The received generation ID is compared with a generation ID stored at the server. When the generation IDs do not match, synchronization with the client is initiated. The synchronization, for instance, may use change sequence numbers which correspond to the respective generation IDs. The change sequence numbers represent a change in state of a corresponding email in the client's email account.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of an exemplary environment in which embodiments of email service and client synchronization may be implemented.

FIG. 2 is an illustration in an exemplary implementation showing various devices and components in an exemplary system in which embodiments of client synchronization may be implemented.

FIG. 3 is a flow diagram depicting a procedure in an exemplary implementation in which Internet email service and client devices are synchronized using generational identifiers.

FIG. 4 is a flow diagram depicting a procedure in an exemplary implementation in which an email service and a client are synchronized using temporary object identifiers.

FIG. 5 is a flow diagram depicting a procedure in an exemplary implementation in which an email service and a client are synchronized using change identifiers.

FIG. 6 is a flow diagram depicting a procedure in an exemplary implementation in which change identifiers are incremented.

FIG. 7 is a flow diagram depicting another procedure in an exemplary implementation in which generation identifiers and change sequence numbers are utilized in conjunction with synchronization positions to synchronized client devices.

The same reference numbers are utilized in instances in the discussion to reference like structures and components.

### DETAILED DESCRIPTION

Overview

Email services have been rapidly growing in popularity during recent years, and now handle huge quantities of email. One reason for the increasing popularity of such services is convenience. For example, a user or client of an Internet email service is often able to access his account, check his email, and send and/or receive email from multiple different computers and/or other client devices. Although such email services offer increased flexibility and convenience to the user, the services are faced with the difficult task of keeping each of the multiple client devices via which a user may access his account synchronized (i.e., “in sync”) with the email service.

Internet email service and client synchronization techniques are described, in which, client devices may upload local changes and download service-side changes in an efficient manner, thereby facilitating efficient client synchronization with the email service. Furthermore, email service and client synchronization may facilitate efficient synchronization, even in cases where the client email account is to be synchronized with multiple client devices.

Aspects of the described techniques for client synchronization may be implemented in any number of different computing systems, environments, and/or configurations, embodiments of Internet email service and client synchronization are described in the context of the following exemplary system architectures. Therefore, although synchronization of email is described in the following examples, it should be apparent that these techniques are equally applicable to synchronization of other data.

In the following discussion, an exemplary environment is first described which is operable to employ synchronization techniques. Exemplary procedures are then described which may be employed in the exemplary environment, as well as in other environments.

Exemplary Environment

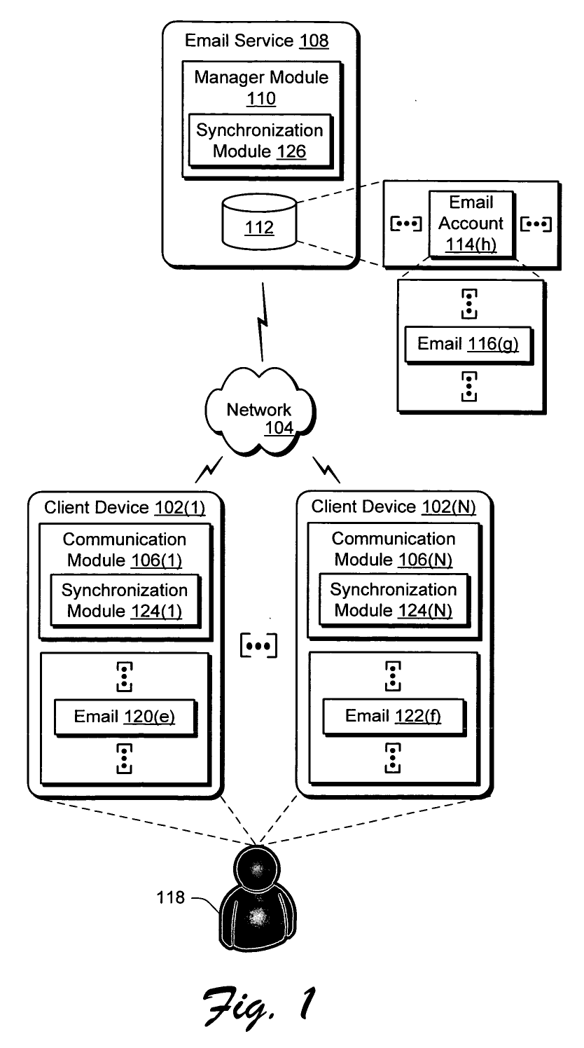

FIG. 1 illustrates an exemplary environment 100 in which embodiments of email service and client synchronization may be implemented. The environment 100 is illustrated as including a plurality of client devices 102(1), . . . 102(n), . . . , 102(N) (hereinafter “clients”) that are communicatively coupled, one to another, over a network 104. The plurality of clients 102(1)-102(N) may be configured in a variety of ways. For example, one or more of the clients 102(1)-102(N) may be configured as a computer that is capable of communicating over the network 104, such as a desktop computer, a mobile station, a game console, an entertainment appliance, a set-top box communicatively coupled to a display device, a wireless phone, and so forth. The clients 102(1)-102(N) may range from full resource devices with substantial memory and processor resources (e.g., personal computers, television recorders equipped with hard disk) to low-resource devices with limited memory and/or processing resources (e.g., traditional set-top boxes). In the following discussion, the clients 102(1)-102(N) may also relate to a person and/or entity that operate the client. In other words, client 102(1)-102(N) may describe a logical client that includes software and/or a machine.

Additionally, although the network 104 is illustrated as the Internet, the network may assume a wide variety of configurations. For example, the network 104 may include a wide area network (WAN), a local area network (LAN), a wireless network, a public telephone network, an intranet, and so on. Further, although a single network 104 is shown, the network 104 may be configured to include multiple networks. For instance, clients 102(1), 102(N) may be communicatively coupled via a peer-to-peer network to communicate, one to another. Each of the clients 102(1), 102(N) may also be communicatively coupled to an email service provider over the Internet. A variety of other instances are also contemplated.

Each of the plurality of clients 102(1)-102(N) is illustrated as including a respective one of a plurality of communication modules 106(1), . . . , 106(N). In the illustrated implementation, each of the plurality of communication modules 106(1)-106(N) is executable on a respective one of the plurality of clients 102(1)-102(N) to send and receive email. Email employs standards and conventions for addressing and routing such that the email may be delivered across the network 104 utilizing a plurality of devices, such as routers, other computing devices (e.g., email servers), and so on. In this way, emails may be transferred within a company over an intranet, across the world using the Internet, and so on. An email, for instance, may include a header, text, and attachments, such as documents, computer-executable files, and so on. The header contains technical information about the source and oftentimes may describe the route the message took from a sender to a recipient.

The communication modules 106(1)-106(N) can communicate emails through use of an email service 108. The email service 108 includes an email manager module 110 (hereinafter “manager module”) that manages storage 112 of a plurality of email accounts 114(h), where “h” can be any integer from one to “H”. Each of the email accounts 114(h) is configured to store a plurality of emails 116(g), where “g” can be any integer from one to “G”, that are configured for communication over the network.

The email service 108, for example, may receive an email intended for the email account 114(h) of a particular user 118. The email service 108, upon receipt of the email, executes the manager module 110 to store the email in the email account 114(h) that corresponds to the particular user 118. The user 118 may then utilize one or more of the client devices 102(1)-102(N), through execution of respective communication modules 106(1)-106(N), to retrieve the email from the corresponding email account 114(h). For example, the user 118 may utilize client 102(N) to “log on” to the email service 108 (e.g., by providing a user identification and password) and retrieve emails from the email account 114(h). In a further instance, the client 102(N) pulls the email from the email provider 108 (and more particularly the manager module 110)). A variety of other instances are also contemplated.

As previously described, the client devices 102(1)-102(N) can also represent multiple different devices via which the user 118 may access a corresponding email account 114(h) at the email service 108. For example, client device 102(1) can be the user's 118 personal computer located at the user's home and client device 102(N) can be the user's 118 mobile phone. Therefore, client device 102(1) may include a plurality of email 120(e) (where “e” can be any integer from one to “E”) and client 102(N) may also include a plurality of email 122(f), where “f” can be any integer from one to “F”. Thus, each client device 102(1)-102(N) may include different respective emails 120(e), 122(f) due to different respective synchronization states with the email 116(g) of the email service 108.

For example, the user 118 may have various emails 116(g) which have been received at his email account 114(h) and may continue to receive additional emails at his email account 114(h) throughout the day. In the morning, for instance, the user 118 may decide to download his email 116(g) from the internet email service 108 to his personal computer (e.g., client 102(1)) at home before leaving for work, which may correspond to email 120(e). Later in the day, the user 118 may check the email account 114(h) from another client 102(N) located at the user's workplace. In another example, the user 118 may have synchronized today with one client 102(1), but may have not synchronized for several days with another client 102(N). In each of these examples, since different clients 102(1)-102(N) have been used to access the email account 114(h) at different times, one or more of the different clients 102(1)-102(N) can have different synchronization states, e.g., the clients 102(1)-102(N) do not have the same emails stored locally.

To synchronize the clients 102(1)-102(N) with the email service 108, the clients 102(1)-102(N) and/or the email service 108 may utilize respective synchronization modules 124(1)-124(N), 126. The synchronization modules 124(1)-124(N), 126 are executable to track each time the user 118 makes a change to a state of an email (e.g., when a new email is received by the client's email account, when one of the respective email is read, or when one of the respective email is moved) and for tracking the synchronization state of each of the different clients 102(1)-102(N). As described in further detail below, this tracking facilitates efficient synchronization on a large scale between multiple clients 102(1)-102(N) and the email service 108.

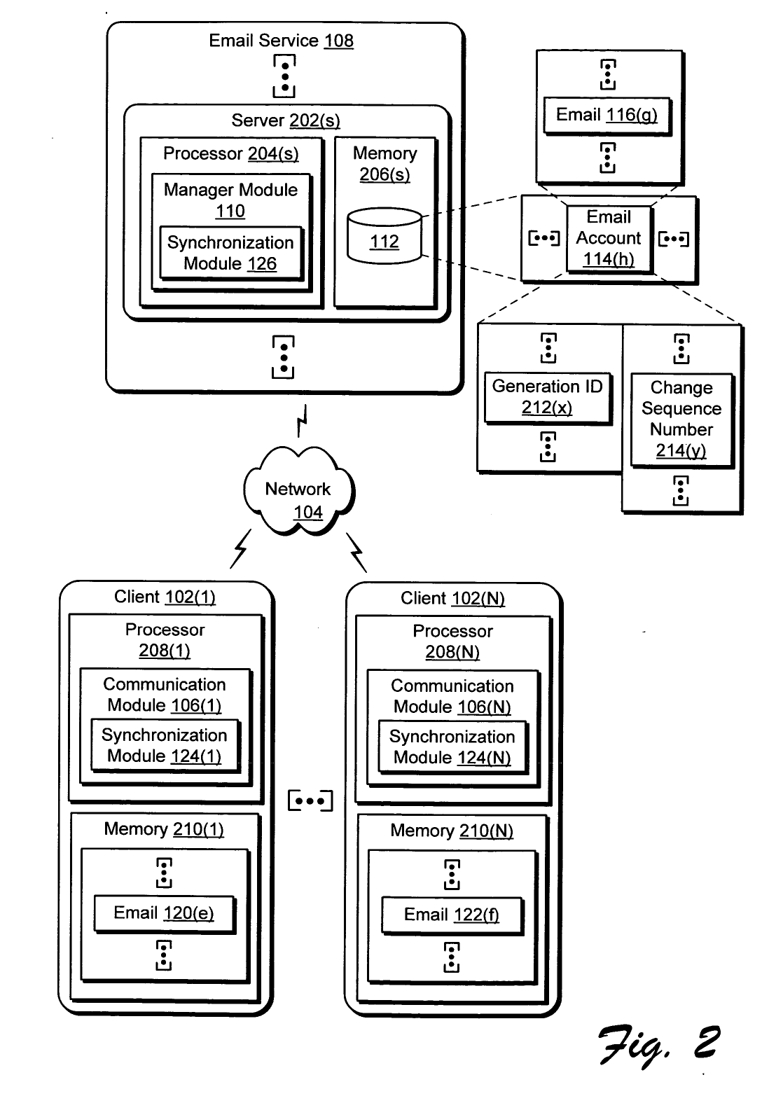

Generally, any of the functions described herein can be implemented using software, firmware, fixed logic circuitry, manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the synchronization strategies described below are platform-independent, meaning that the strategies may be implemented on a variety of commercial computing platforms having a variety of processors.

FIG. 2 illustrates an exemplary system 200 in which the email service 108 and the clients 102(1)-102(N) of FIG. 1 are shown in greater detail. The email service 108 is illustrated as being implemented by a plurality of servers 202(s), where “s” can be any integer from one to “S”. Each of the servers 202(s) includes a respective processor 204(s) and memory 206(s). Likewise, each of the clients 102(1)-102(N) includes a respective processor 208(1)-208(N) and memory 210(1)-210(N). As used herein, processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth.

Additionally, although a single memory 206(s), 210(1)-210(N) is shown for the respective servers 202(s) and clients 102(1)-102(N), the memories 206(s), 210(1)-210(N) may represent a wide variety of types and combinations of memory devices, such as random access memory (RAM), hard disk memory, removable medium memory, and other computer-readable media.

The manager module 110 and the synchronization module 126 are illustrated as being executed on the processor 204(s) and are also storable in memory 206(s). The synchronization module 126 is representative of functionality that is employable by the manager module 110 to synchronize emails 116(g) in the email accounts 114(h) with clients 102(1)-102(N) over the network. For example, the synchronization module 126, when executed, may maintain a plurality of generation IDs 212(x) and change sequence numbers 214(y), where “x” and “y” can be any integer from one to “X” and “Y”, respectively. The change sequence numbers 214(y) are utilized to represent changes to a state of the email 116(g) in the email account 114(h), such as deletion, addition, movement from one folder to another, and so on.

The generation IDs 212(x) may be configured as monotonically increasing integers used to mark a current synchronization position in order to detect a recovery synchronization scenario. After the email service 108 (and more particularly the manager module 110) successfully processes a synchronization request between the client 102(1) and the corresponding email account 114(h), for instance, the stored generation ID 212(x) is incremented and sent back to the client 102(1). If in a subsequent synchronization request, the client 102(1) still sends the previous generation ID, then the email service 108 “knows” that the client 102(1) failed to receive the synchronization response with the updated generation ID. Recovery synchronization may then be performed. Further discussion of the generation ID 212(x) may be found in relation to the exemplary procedures section that follows.

Exemplary Procedures

The following discussion describes synchronization techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. Thus, the order in which the procedures are described is not intended to be construed as a limitation, and any number of the described blocks can be combined in any order to implement the procedures. Furthermore, the procedures may be implemented in any suitable hardware, software, firmware, or combination thereof. In portions of the following discussion, reference will be made to the environment 100 of FIG. 1 and the system 200 of FIG. 2.

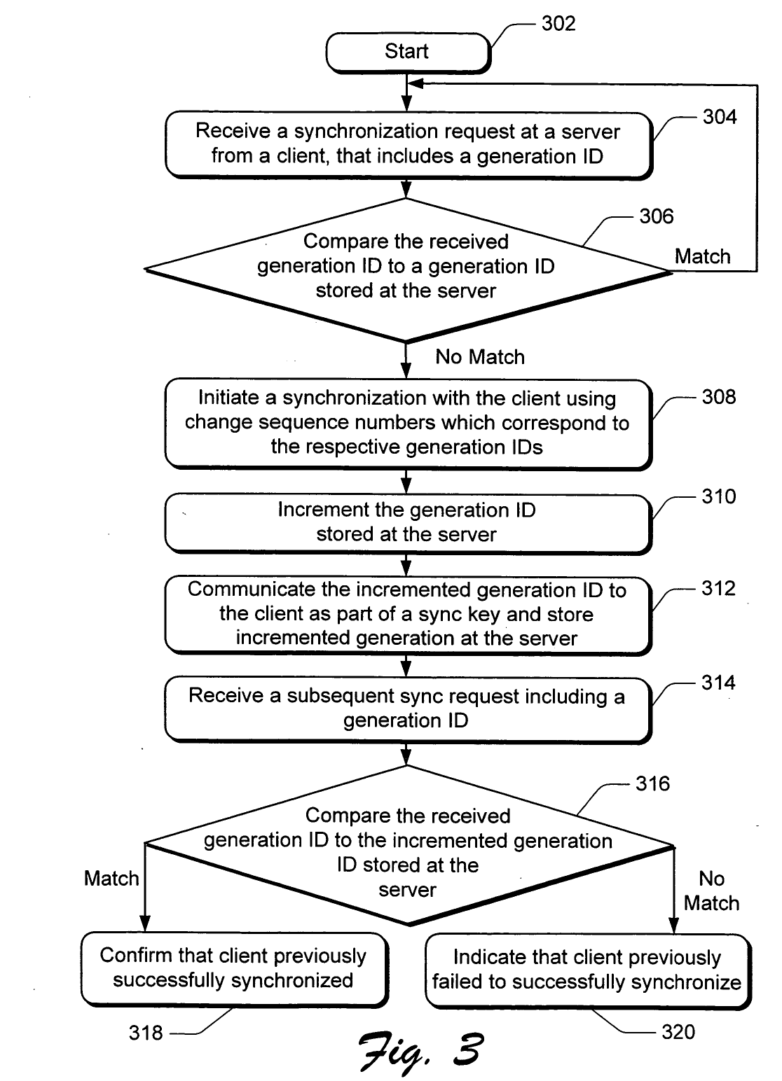

FIG. 3 illustrates an exemplary procedure 300 to synchronize an email service and a client, and is described with reference to the environment 100 and system 200 shown respectively in FIGS. 1 and 2. The procedure 300 is initiated (block 302), and then a synchronization request is received at a server from a client to synchronize the client's email account (block 304). The synchronization request includes a generation identifier (ID) that identifies a group of changes to the email account which have been processed by the client. For example, a synchronization request is received at a server 202(s) from a client 102(1) to synchronize the client's email account 114(h). The synchronization request includes a generation identifier (ID) that identifies a group of changes to the email account 114(h) which have been processed by the client 102(1).

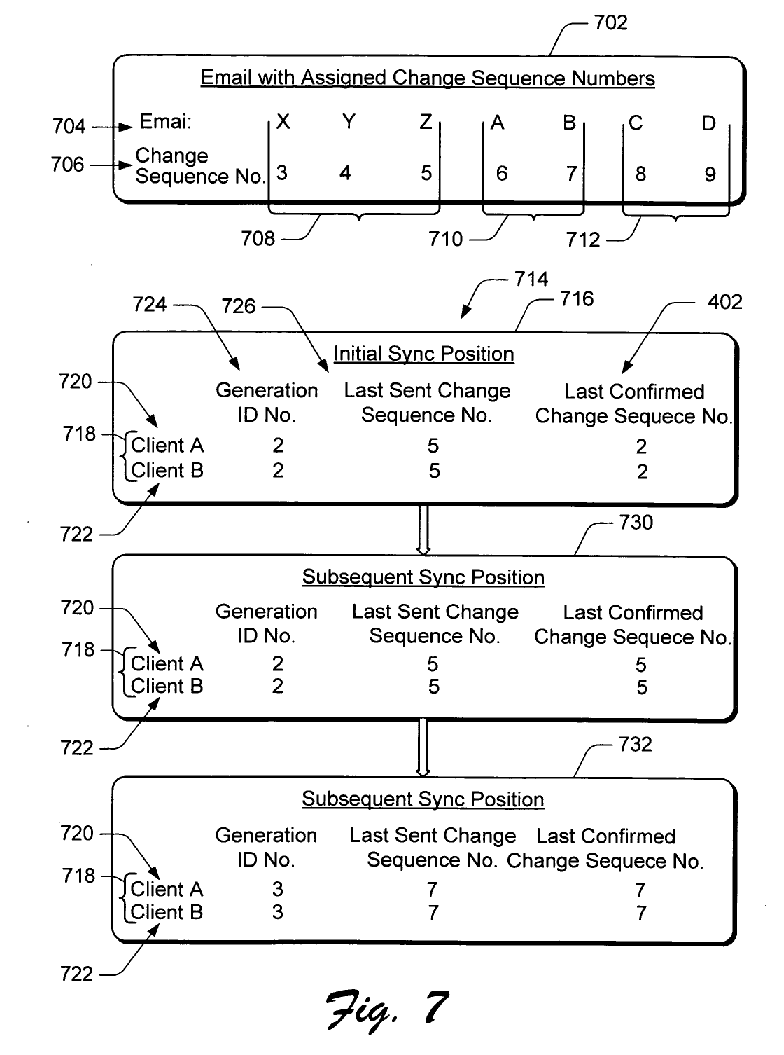

The generation ID received from the client is compared to a generation ID stored at the server (decision block 306). For example, the generation ID received from client 102(1) is compared to a generation ID 212(x) stored at the server 202(s) to determine whether the generation ID received from the client 102(1) matches the generation ID for that client stored at the server 202(s). The server 202(s), for instance, may store generation IDs that are specific for each client that is to synchronize with the server such that a first client may have a first generation ID which maps to a particular change number while another generation ID may map to another change number. Further discussion of multi-client synchronization may be found in relation to FIG. 7.

When the generation IDs do not match (“no” from decision block 306), synchronization is initiated with the client (block 308). The synchronization uses change sequence numbers which correspond to the respective generation IDs. Each of the change sequence numbers represents a change in state of a corresponding email in the client's email account.

The generation ID stored at the server is also incremented (block 310). For example, the generation ID 212(x) stored at the server 202(s) can be incremented. The incremented generation ID is communicated to the client as part of a synchronization key to mark an updated synchronization state for the client 102(1) (block 312). For example, the incremented generation ID can be communicated from the server 202(s) to the client 102(1) as part of a synchronization key to mark an updated synchronization state for the client 102(1).

A subsequent synchronization request is then received at the server 202(s) from the client 102(1) to synchronize the client's email account (block 314). The subsequent synchronization request includes a generation ID. For example, a subsequent synchronization request can be received at the server 202(s) from the client 102(1) over the network 104 to synchronize the client's email account 114(h). The subsequent synchronization request includes a generation ID.

The generation ID received from the client is then compared to the incremented generation ID stored at the server (decision block 316). For example, the generation ID received from the client 102(1) can be compared to the incremented generation ID stored at the server 202(s) to determine whether the generation ID received from the client 102(1) matches the incremented generation ID.

When the generation IDs match (“yes” from decision block 316), the matching of the generation ID received from the client with the incremented generation ID stored at the server confirms that the client has previously successfully synchronized with the client's email account (block 318). For example, when the generation ID received from the client 102(1) matches the incremented generation ID stored at the server 202(s), the matching confirms that the client 102(1) has previously successfully synchronized with the client's email account 114(h).

When the generation IDs do not match (“no” from decision block 316), a non-matching of the generation ID received from the client with the incremented generation ID stored at the server confirms that the client has not previously successfully synchronized with the client's email account (block 320). Thus, the email service 108 is “made aware” of the synchronization state of the client, and may perform appropriate actions. For example, the procedure 300 may return to block 308 to retry the synchronization process.

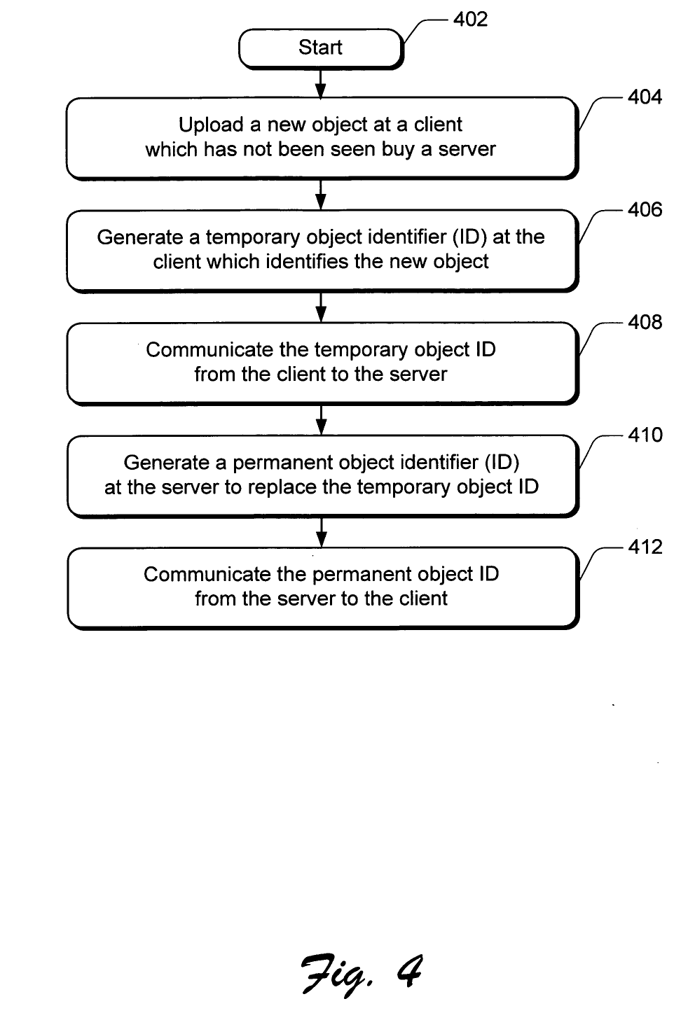

FIG. 4 depicts a procedure 400 in an exemplary implementation in which a temporary object identifier is generated and utilized during synchronization. The procedure 400 is initiated (block 402), and then a new object (e.g., an email, document, and so on) which has not been seen by a server is uploaded at a client (block 404). For example, an email which has not been seen by a server 202(s) may be uploaded at client 102(1), such as an email composed on the client.

A temporary object identifier (ID) which identifies the new object is generated at the client (block 406). The temporary object ID is then communicated from the client to the server (block 408). For example, the temporary object ID can be communicated from the client 102(1) to the server 202(s) which is used by the client 102(1) to identify the locally composed email.

A permanent object identifier (ID) is then generated at the server to replace the temporary object ID (block 410). For example, a permanent object identifier (ID) can be generated at the server 202(s) to replace the temporary object ID used and communicated by the client. The permanent object ID is communicated from the server to the client (block 412). For example, the permanent object ID can be communicated from the server 202(s) to the client 102(1) such that the permanent object ID may be utilized by the client 102(1) when referencing the composed email. Again, although email has been described, a wide variety of electronically-stored objects may be synchronized utilizing these techniques.

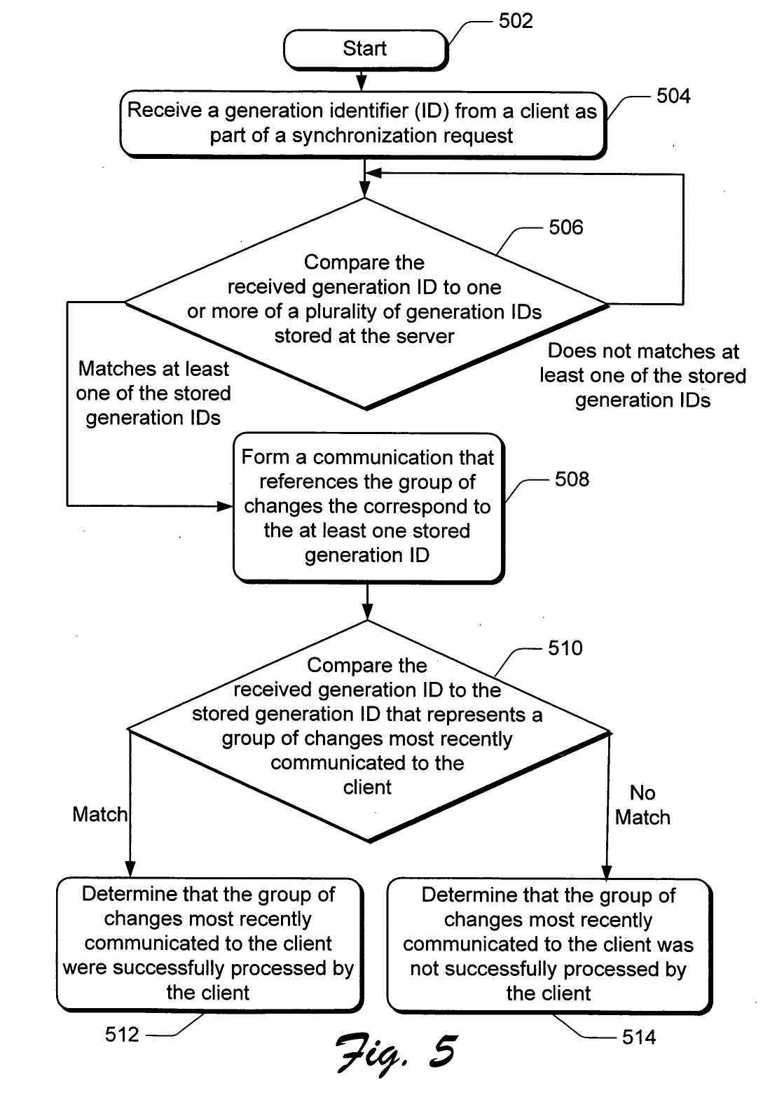

FIG. 5 depicts a procedure 500 in an exemplary implementation in which generation IDs and change sequence numbers are utilized to synchronize a client. The procedure 500 is initiated (block 502), and then a generation identifier (ID) is received from a client as part of a synchronization request (block 504). For example, a generation ID can be received by the server 202(s) of the email service 108 from client 102(1) as part of a synchronization request.

The generation ID received from the client is then compared to one or more of a plurality of generation IDs stores at the server (decision block 506). For example, the generation ID received can be compared to one or more of a plurality of generation IDs stored at the server 202(s). At least one of the stored generation IDs represents a group of changes that was most recently communicated to the client, and another of the stored generation IDs represents a group of changes confirmed to have been most recently processed by the client, which was confirmed by reception from the client of the corresponding generation ID at sometime in the past. Each of the changes in a group relates to a change in state of an email in an email account that corresponds to the client.

When the generation ID received from the client matches at least one of the stored generation IDs (“yes” from decision block 506), a communication that references the group of changes that correspond to the at least one said stored generation ID is formed (block 508). Thus, receipt of a generation ID confirms which changes the client has processed and identifies a group of changes the client has received. The server may then form a communication that contains the change that the client has not received. These may include changes corresponding to later generation IDs and new changes that do not yet have a generation ID.

During the matching, the generation ID received from the client is also compared to the stored generation ID that represents a group of changes that was most recently communicated to the client (decision block 510). For example, the generation ID received from the client 102(1) can be compared to the stored generation ID that represents a group of changes that was most recently communicated to the client 102(1).

When the generation ID received from the client matches the at least one stored generation ID that represents the group of changes that was most recently communicated to the client (“yes” from decision block 510), it is determined that the group of changes that was most recently communicated to the client was successfully processed by the client (block 512). Thus, the synchronization state of the client matches the synchronization state “expected” by the email service.

When the generation ID received from the client does not match the at least one stored generation ID that represents the group of changes that was most recently communicated to the client (“no” from decision block 510), it is determined that the group of changes that was most recently communicated to the client was not successfully processed by the client. Therefore, a recovery scenario may be performed, such as by resending the changes as well as the newer changes to the client.

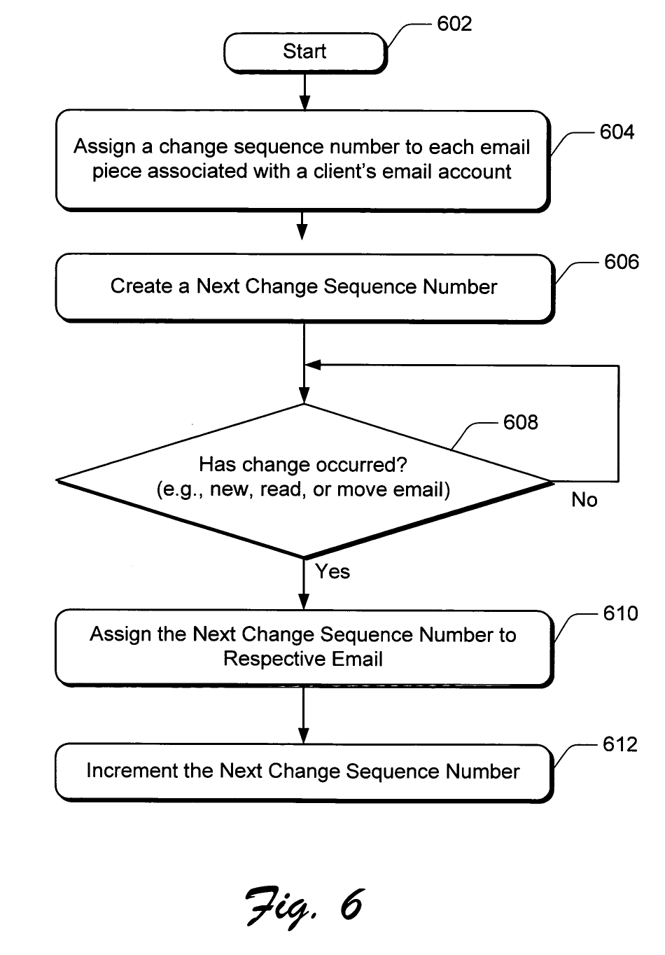

FIG. 6 depicts a procedure 600 in an exemplary implementation in which change sequence number are assigned to changes in an email account. Although change sequence numbers are described, it should be apparent that change sequence numbers are one of a variety of techniques that may be utilized to track changes by the server. The server may employ a variety of other techniques to compute a set of changes that correspond to a generation ID. The procedure 600 is initiated (block 602), and then a change sequence number is assigned to each respective email associated with the client's email account (block 604). For example, as shown in FIG. 7, a change sequence number 706 can be assigned to each respective email 704 associated with the client's email account.

A next change number is then created (block 606) for subsequent changes. In one implementation, the next change number can be monotonically incremented each time there is a change and applies to objects in all the collections within an email account 114(h). For example, if fifty changes were to happen in rapid succession, there will be a different monotonically incremented change sequence number assigned to the email 116(g) associated with the email account 114(h) for each of the fifty changes. It should be apparent however, that a variety of techniques may be employed to track changes. For example, different sets of sequence numbers may be employed for different parts of an email account, e.g., one for an inbox and another for all other folders, a sequence number for calendar items, and so on. Tracking the next change number allows the Internet email service 108 to conveniently assign change sequence numbers to any new changes.

A determination is then made as to whether a change has occurred (decision block 608). For example, it is determined whether a new email 116(g) is received by the client's email account 114(h), whether one of the respective email 114(h) is read, whether one of the respective email 114(h) is moved, and so on.

When it is determined that a change has occurred (“yes” from decision block 608), then the next change sequence number (706 of FIG. 7) is assigned to the respective email 116(g) (block 610). Also, the next change number is then incremented (block 612). Thus, the change sequence number in this instance is utilized to track changes to the state of any one of the emails stored in the email account.

FIG. 7 depicts a procedure 700 in an exemplary implementation for email service and client synchronization. The illustrated example shows various aspects of both tracking the synchronization states of the clients and of tracking actual changes. Actual changes include things such as receipt of a new email 116(g) by the client's email account 114(h), opening of an email, an/or moving an email. To track actual changes, each individual email can be assigned a change sequence number. Table 702 at the top of FIG. 7, provides a list of several individual emails 704 (i.e., emails X, Y, Z, A, B, C, and D) along with a list of change sequence numbers 706 (i.e., change sequence number 3, 4, 5, 6, 7, 8, and 9) which have been respectively assigned to the emails 704. For example change sequence number “3” has been assigned to email “X”, change sequence number “4” has been assigned to email “Y”, change sequence number “5” has been assigned to email “Z”, and so forth. In the example shown, the email 704 is separated into a first group of email 708 (which includes email X, Y, and Z), a second group of email 710 (which includes email A and B), and a third group of email 712 (which includes email C and D). In the present example, these three sets of email 708, 710, and 712 are received by the email service at different times as described below.

In an implementation, the change sequence number 706 assigned to an email 704 can be an integer that is monotonically increased each time there is a change. For example, the change sequence numbers can be consecutive integers such as 3, 4, and 5 (as shown), can be non-consecutive integers like 1, 3, and 6, and so on. In either case, the integer for a particular email 704 is increased each time there is a change. Therefore, when comparing two change sequence numbers 706 in this instance, the larger change sequence number 706 represents the change which happened more recently. In an implementation, these change sequence numbers 706 are stored in the memory 206(s) of the server 202(s), and the clients 102(1)-102(N) will not see the change sequence numbers 706. Instead, the clients 102(1)-102(N) will see a generation ID number that is sent back to the client as part of a synchronization key. The emails and corresponding change sequence numbers described in relation to table 702, are further described below with reference to flow diagram 714.

Reference numeral 716 points to a first box of the flow diagram 714. This first box 716 of the flow diagram 714 shows an initial synchronization position of two clients 718, shown here as “client A” 720 and “client B” 722. In the illustrated example, three different numbers are associated with each of the two clients 718. These three numbers include: a generation ID number 724 (which is stored at server), a last sent change sequence number 726, and a last confirmed change sequence number 728. The last sent change sequence number 726 and the last confirmed change sequence number 728 are change sequence numbers 706 that have been assigned to a particular email 704, and the generation identifier (ID) 724 is a number with can be used by the Internet email service 108 to track the synchronization state of a client (e.g., “client A” 720 or “client B” 722).

In this example, the user's email account 114(h) at the email service 108 has three emails (i.e., emails X, Y, and Z), and both clients 718 are synchronized with the user's email account 114(h). In other words, there are three emails (i.e., X, Y and Z) and both of the clients 718 (i.e., “client A” 720 and “client B” 722) have all three email. In the present example, both of the clients 718 are on generation ID=2, and further, the last time the clients 718 synchronized with the email service 108, the email service 108 sent both of the clients 718 the first group of emails 708 (which includes emails X, Y, and Z). In other words, the clients 718 were sent emails 708 with corresponding change sequence number 706 up to five (i.e., emails X=3, Y=5, and Z=5). Therefore, both of the clients 718 have seen up to change sequence number five. In addition, the last time the clients 718 synchronized with the email service 108, the email service 108 sent both of the clients 718 a synchronization key that included generation ID=2.

It should be noted that although the Internet email service 108 knows that it sent the first group of emails 708 with corresponding change sequence numbers 706 up to five (i.e., emails X=3, Y=5, and Z=5) to both of the clients 718, at this point, the email service 108 does not know if the clients 718 received these emails 708.

Therefore, the next time the clients 718 synchronize, if the previous synchronization was successful and the clients 718 received everything up to change sequence number five, then the clients 718 will send the email service 108 the same generation ID that was sent them during the last synchronization. In the present example, the clients 718 will send a generation ID=2 to the email service 108 in the next synchronization request if the previous synchronization was successfully performed by the client. The receipt of this generation ID in the next request provides the email service 108 with confirmation that the clients 718 are “up-to-date” through change sequence number five.

As shown in block 730, now that the email service 108 has confirmation that the clients 718 are up-to-date, the last confirmed change sequence number is column is made a “5”. Continuing with the example, two more email 710 (i.e., email “email A” and “email B”) are received by the email service 108, and therefore “email A” is assigned a “change sequence number=6”, and that “email B” is assigned a “change sequence number=7”. The email service 108 then receives a synchronization request from the clients 718, and in response sends the two new email pieces 710 (i.e., “email A” which corresponds to change sequence number 6 and “email B” which corresponds to change sequence number 7) to the clients 718. At this point, the last sent change sequence number is set at 7, and the generation ID number is incremented to 3. The response which is sent to the clients 718 will include the emails (e.g., email A and email B) and the synchronization key will include generation ID=3. However, as before, when the email service 108 sends the changes to the clients 718, the email service 108 does not receive any confirmation that the clients 718 actually received the changes.

The next time the clients 718 synchronize, when the previous synchronization was successful and the clients 718 are synchronized through change sequence number=7, then the clients 718 send the email service 108 the same generation ID that was sent in the response. In the present example, the clients 718 will send the email service 108 a generation ID=3 in the next synchronization request when the previous synchronization was successful. This provides confirmation to the email service 108, that the clients 718 are “up-to-date” through change sequence number=7.

As shown in block 732, now that the email service 108 has confirmation that the clients 718 are up-to-date through change sequence number=7, the last confirmed change sequence number column is set at “7”.

Continuing with the present example, two more pieces of email 712 (i.e., “email C” and “email D”) are received by the email system 108. As described previously, “email C” is assigned a change sequence number=8, and “email D” is assigned a change sequence number=9. Again, the clients 718 send a synchronization request to the email service 108, and that in response to the synchronization request, the email service 108 sends the clients 718 the new changes 712 (i.e., the two new email pieces with corresponding change sequence numbers of C=8 and D=9). Now the last sent change sequence number is set at 9, and the generation ID number is incremented to 4. Therefore, the response which is sent from the email service 108 to the clients 718, will include “email C” and “email D”, and the synchronization key will include generation ID number=4. However, as before, when the email service 108 sends the changes 712 to the clients 718, the email service 108 does not immediately receive a confirmation that the clients 718 actually received the changes. In the present example, assume that for some reason, “email D” failed to be transmitted to the client via the network, and so the client 718 has not received “email D”.

In such a situation, when the client 718 sends another synchronization request to the email service 108, the synchronization request will include generation ID=3 (the request will not include generation ID=4). The email service 108 will recognize that the client 718 sent the previous generation ID number 3, thereby indicating that the client 718 did not receive the previously transmitted changes 712.

In response to the synchronization request, the email service 108 will send the clients 718 “email C” and “email D”. This is a recovery synchronization that allows the email service 108 to handle the failure of the earlier transmission.

If the client 718 sends the email service 108 the expected generation ID (e.g., generation ID=4) or the previous generation ID (e.g., generation ID=3), the server 202(s) will handle the synchronization request. However, if the client 718 sends the email service 108 an erroneous generation ID (e.g., “generation ID=1”), the email service 108 will advise the client 718 that the synchronization request is invalid, and will direct the client 718 to restart synchronization from scratch.

### CONCLUSION

Although embodiments of Internet email service client synchronization have been described in language specific to structural features and/or methods, it is to be understood that the subject of the appended claims is not necessarily limited to the specific features or methods described. Rather, the specific features and methods are disclosed as exemplary implementations of Internet email service client synchronization.

1. A method comprising:
receiving a synchronization request at a server from a client to synchronize with an email account, wherein the synchronization request includes a generation identifier (ID) that identifies a group of changes to the email account which have been processed by the client;
comparing the received generation ID to a generation ID stored at the server; and
when the generation IDs do not match, initiating a synchronization with the client, the synchronization using change sequence numbers which correspond to the respective generation IDs, wherein each said change sequence number represents a change in state of a corresponding email in the email account.

2. The method of claim 1, further comprising:
when initiating the synchronization with the client, incrementing the generation ID stored at the server; and
communicating the incremented generation ID to the client as part of a synchronization key to mark an updated synchronization state for the client.

3. The method of claim 2, further comprising:
receiving a subsequent synchronization request at the server from the client to synchronize the client's email account, wherein the subsequent synchronization request includes a generation ID; and
comparing the received generation ID to the incremented generation ID stored at the server, wherein the generation IDs, when matching, confirm that the client has previously successfully synchronized with the client's email account.

4. The method of claim 2, further comprising:
receiving a subsequent synchronization request at the server from the client to synchronize the client's email account, wherein the subsequent synchronization request includes a generation ID;
comparing the received generation ID to the incremented generation ID stored at the server, wherein the generation IDs, when non-matching, confirm that the client has not previously successfully synchronized with the client's email account.

5. The method of claim 1, further comprising:
assigning said change sequence numbers to each respective email associated with the client's email account; and
incrementing said change sequence numbers for the respective email when a new email is received by the client's email account, when the respective email is read, or when the respective email is moved.

6. The method of claim 1, further comprising:
assigning a next change number globally to the email associated with the client's email account; and
incrementing said next change number globally for the email associated with the client's email account when a new email is received by the client's email account, when one of the emails is read, or when one of the emails is moved.

7. The method of claim 1, further comprising:
uploading a new object at the client, wherein the new object has not been seen by the server;
generating a temporary object identifier (ID) at the client which identifies the new object that has been uploaded;
communicating the temporary object ID from the client to the server;
generating a permanent object ID at the server to replace the temporary object ID; and
communicating the permanent object ID from the server to the client, wherein the permanent object ID is utilized by the client when subsequently identifying the new object.

8. The method of claim 1, wherein the change sequence numbers which correspond to the respective generation IDs include:
a first change sequence number that represents a respective said email associated with the client's email account that was most recently sent to the client; and
a second change sequence number that represents a respective said email associated with the client's email account that has been confirmed to have been processed by the client.

9. The method of claim 1, wherein the client is one of a plurality of clients that have access to the email account and further comprising:
marking at least one said email for deletion from the client's email account with a tombstone indicator, wherein the tombstone indicator indicates that the at least one said email has not been viewed by each of the plurality of clients; and
deleting the email after it has been viewed by each of the plurality of clients.

10. A method comprising:
comparing a generation identifier (ID) received from a client to one or more of a plurality of generation IDs stored at a server, wherein:
at least one said stored generation ID represents a group of changes that was most recently communicated to the client;
another said stored generation ID represents a group of changes confirmed to have been most recently processed by the client; and
each said change relates to a change in state of an electronically stored object that corresponds to the client; and
when the generation ID received from the client matches at least one said stored generation ID, forming a communication that references the group of changes that correspond to the at least one said stored generation ID.

11. The method of claim 10, further comprising when the generation ID received from the client matches the at least one said stored generation ID that represents the group of changes that was most recently communicated to the client, determining that the group of changes that was most recently communicated to the client was successfully processed by the client.

12. The method of claim 10, further comprising when the generation ID received from the client does not match the at least one said stored generation ID that represents the group of changes that was most recently communicated to the client, determining that the group of changes that was most recently communicated to the client was not successfully processed by the client; and
communicating the group of changes that was not successfully processed to the client.

13. One or more computer readable media comprising computer executable instructions that, when executed, direct a computer to:
form a synchronization request to synchronize with a user's email account, wherein the synchronization request includes a generation identifier (ID) that identifies a group of changes to the email account which have been processed by the computer; and
when the generation ID does not match a generation ID that is associated with the user's email account at an email service, synchronize the email account using one or more change sequence numbers at the email service which correspond to the respective generation IDs, wherein each said change sequence number represents a change in state of a corresponding email in the user's email account.

14. The one or more computer readable media as describe in claim 13, wherein the synchronization request causes the email service to:
increment the generation ID stored at the email service when initiating the synchronization with the computer; and
communicate the incremented generation ID to the computer as part of a synchronization key to mark an updated synchronization state for the client.

15. The one or more computer readable media as describe in claim 14, wherein the computer executable instructions further direct the computer to form a subsequent synchronization request to synchronize with the user's email account, wherein the subsequent synchronization request includes a generation ID, wherein the subsequent synchronization request causes the email service to compare the received generation ID to the incremented generation ID, wherein the generation IDs, when matching, confirm that the client previously successfully synchronized with the client's email account.

16. The one or more computer readable media as describe in claim 14, wherein the computer executable instructions further direct the computer to wherein the computer executable instructions further direct the computer to form a subsequent synchronization request to synchronize with the user's email account, wherein the subsequent synchronization request includes a generation ID, wherein the subsequent synchronization request causes the email service to compare the received generation ID to the incremented generation ID, wherein the generation IDs, when non-matching, confirm that the computer has not previously successfully synchronized with the user's email account.

17. The one or more computer readable media as describe in claim 16, wherein the synchronization request causes the email service to initiate a recovery synchronization with the computer using the change sequence numbers which correspond to the respective generation IDs to determine what is to be sent to the computer.

18. The one or more computer readable media as describe in claim 16, wherein the computer executable instructions further direct the computer to:
generate a temporary object identifier (ID) at the client which identifies a new object that has been uploaded at the computer;
communicate the temporary object ID to the email service;
generate a permanent object ID at the email service to replace the temporary object ID; and
communicate the permanent object ID from the email service to the client, wherein the client uses the permanent object ID when subsequently identifying the new object.

19. The one or more computer readable media as describe in claim 13, wherein:
said change sequence numbers are assigned to each respective email associated with the user's email account; and
said change sequence numbers are incremented for each of the respective emails when a new email is received by the user's email account, when the respective email is read, or when the respective email is moved.

20. The one or more computer readable media as describe in claim 13, wherein:
a next change number is assigned globally to the email associated with the user's email account; and
said next change number is incremented globally for the email associated with the user's email account when a new email is received by the user's email account, when email is read, or when email is moved.
